(19) United States
(12) Patent Application Publication
(10) Pub. No.: US 2008/0003197 A1
(43) Pub. Date: Jan. 3, 2008

(54) Controlled release attractant for gravid female mosquitoes

(76) Inventor: James Robert Bette, Athens, GA (US)

Correspondence Address: James R. Bette, 145 Biscayne Drive, Athens, GA, 30606, US

(21) Appl. No.: 11/809,936

(22) Filed: Jun. 4, 2007

Related U.S. Application Data
(60) Provisional application No. 60/814,811, filed on Jun. 19, 2006.

(51) Int. Cl. A01N 43/38; A01N 43/02; A01N 63/00; A01P 19/00

(52) U.S. Cl. 424/84

(57) ABSTRACT

One or a combination of known chemical cues that attract pregnant female mosquitoes to an egg-laying site are embedded in a biodegradable carrier that releases the compound at a generally constant rate for several weeks or longer. The compound is useful for attracting large numbers of mosquito vectors to a site where they and their progeny can be eliminated.

### CROSS-REFERENCE TO RELATED APPLICATIONS

This application claims the benefit of provisional patent application No. 60/814,811, filed Jun. 19, 2006 by the present inventor.

### STATEMENT REGARDING FEDERALLY SPONSORED RESEARCH AND DEVELOPMENT

Not Applicable

### SEQUENCE LISTING OR PROGRAM

Not Applicable

### BACKGROUND OF THE INVENTION

1. Field of the Invention

This invention relates to a substance or a combination of substances known to attract gravid (pregnant) female mosquitoes. The composition(s) can be formulated as an aqueous emulsion and then suspended in a “carrier”. The composition(s) are useful for inducing gravid female mosquitoes to deposit (oviposite) her eggs at a breeding site containing the attractant, such as a No Maintenance Lethal Mosquito Breeding Trap or other mosquito control device, where they and/or their progeny can be eliminated.

2. Background and Related Art

Gravid female mosquitoes must be able to find suitable sites for depositing their eggs to insure the continuation of the species. Evidence indicates that one means in her decision making process is triggered by habitat related semio-chemicals (behavior changing chemicals) and this knowledge can be exploited to produce ovitraps for monitoring and control. Laurence, B. R. and Pickett, J. A. (1985) Bull.Ent.Res. 75; 283-290 discovered that the mosquito Culex quinquefasctatus, vector for West Nile Virus, Encephalitis, Lymphatic Filariasis, and a host of other debilitating and sometimes deadly diseases, produces the pheromone heterocyclic diasteroisomeric lactone mixture, (5R,6S)-6-acetetoxy-5-hexadecanolide which volatizes from the tips of the eggs in the egg rafts over a 48 hour period after she deposits them. This pheromone attracts other females of the same species to lay gregariously in the same larval habitat. Similarly, the compound 3-Methyl indole, also known as Skatole, a malodorous compound that signals organic enrichment, is a highly effective attractant to gravid female C. quinquefasciatus (Arthropod Semiochemicals; Mosquitos, Midges and Sea Lice, Biochem. Soc. Trans., 2001, 31, 128-133, A. J. Mordue Luntz). A subsequent study (Laboratory and Field Responses of the Mosquito Culex quinquefasciatus, to Plant-Derived Culex spp. Oviposition Pheromone and the Oviposition Cue Skatole, published by in the Journal of Chemical Ecology, 2004 May; 30(5): 965-76 by Olaghemiro T. O., Birkett M. A., Mordue Luntz A. J., Pickett J. A.) concluded that the attractancy of the two substances were, in some cases, synergistic ie; their combined attractancy was greater than their individual attractancies added together at certain concentrations, and that this synergistic result could be achieved by production of the pheromone from a renewable botanical source. The Vector Control Research Center in Pondicherry, India has identified the Secondary Metabolites of the fungus Trichoderma viride as also attractive for the ovipositing female Culex quinquefasciatus (Oviposition Response of the Mosquito, Culex quinquefasciatus to the secondary Metabolite(s) of the Fungus, Trichoderma viride, Mem. Inst. Oswaldo Cruz vol. 98 no. 2 Rio de Janeiro March 2003; I Geetha; K P Paily; V Padmanaban; K Balaraman). The same research center found that there is attractancy to gravid female Anopholes subpictus and Aedes aegypti from a wood inhabiting fungus (Oviposition Attractancy of an Infusion From a Wood Inhabiting Fungus for Vector Mosquitoes, Indian Journal of Medical Research, Jul. 1, 2001; 14:18-24; Sivagnaname N, Amaoraj D D, Kalyanasundaram M, Das P K.

These attractants are used in mosquito traps that collect specimens for monitoring mosquito populations, collecting laboratory breeding stock, and other scientific purposes. As a general rule these traps contain a fan, a light source, and a power source such as a battery or power cord, and are placed in the out-of-doors for several days, in likely places to gather mosquitoes. The above mentioned attractants, when added to these specimen gathering devices, reduce the time spent in the field by attracting more than the normal amount of samples in a short period of time. A “No Maintenance Lethal Mosquito Breeding Trap” has been submitted for patent approval in the USPTO as application Ser. No. 11/263,317 dated Oct. 31, 2005. This unique device is made from biodegradable material and refills itself with rain water. Containing a long lasting larvicide, the trap is set out at the beginning of the mosquito breeding season and requires no further “maintenance” and when gravid female mosquitoes deposit their eggs in it, both they and their progeny are eliminated. The trap biodegrades at the end of the mosquito breeding season foreclosing the possibility of the trap converting to an incubator. The controlled release attractant that is the subject of this RPA, among other things, is designed to improve the efficiency of this trap.

Other forms of mosquito control devices include the “Mosquito Dunk” or “Mosquito Donut” manufactured by Summit Chemical Corp., Altosid Briquets made by Welimark International, and various types of granules, pellets, liquids and powders made by Valent Bio Sciences, to name a few. The Mosquito Donut is a donut shaped floating amalgamation of cork granules bound together with gypsum and impregnated with the larvacide Bacillus thuringiensis israelensis (BTI). When placed in standing water or any site likely to breed mosquitoes, the floating device delivers a steady stream of larvicide for about 3 weeks and eliminates mosquito larva before they can mature. Similarly, the Altosid Briquet is placed in storm drain catch basins and other likely mosquito breeding sites where it sinks to the bottom and gradually dissolves releasing Methoprene, an Insect Growth Regulator (IGR), for up to 6 months, which interrupts the insects growth cycle, and eliminates them. The Valent Bio Sciences products also use BTI and other eco-friendly larvicides in their array of products that are introduced into likely mosquito breeding areas by various means. These and similar products could be greatly enhanced by the addition of the controlled release attractants that are the subject of this application since greater numbers of gravid female mosquitoes would be induced to deposit their eggs in lethal sites rather than competing non-lethal sites.

There are no controlled release substances for attracting gravid female mosquitoes, thus there is a need for such substances.

The concept of using an aqueous emulsion suspended in a carrier, such as wax, to achieve a controlled release of a pheromone or similar substance or combination of substances is not new. U.S. Pat. No. 6,001,346 entitled Aqueous emulsion comprising biodegradable carrier and methods for controlled release thereof describes the process of embedding the sex pheromone of the Oriental Fruit Moth in a sprayable form where it is then introduced into orchards and sprayed onto tree trunks. As the substance naturally biodegrades over several months, the breeding period of the moths, the sex pheromone is continuously released, thereby confusing the males who cannot find a mate and the breeding cycle is thus interrupted.

### OBJECTS AND ADVANTAGES

Attractants developed to lure gravid female mosquitoes to a trap for scientific monitoring or breeding purposes all have the purpose of increasing the capture rate of these insects in a condensed period of time. The primary reason for this is to reduce the time spent in the field by investigators of all sorts, thereby reducing costs. Another reason is to concentrate the species under examination so as to not have to deal with superfluous strains, thereby wasting investigative resources. The controlled release mechanisms described here bring these concepts out of the scientific laboratory and into a form usable for mass mosquito control worldwide in an environmentally friendly form. Accordingly, several objects and advantages of this invention are:
a.) To attract mosquitoes, and in particular mosquito vectors that spread infections and deadly diseases in humans, to a device where they and their progeny can be eliminated.
b.) To provide a means for a controlled release of attractants for gravid female mosquitoes to a mosquito control device site for several weeks or more.
c.) To provide a control device that is specific to mosquitoes.
d.) To increase the efficiency of certain mosquito control devices.

### DETAILED DESCRIPTION OF THE INVENTION

The current invention provides a composition for the continuous release of a pheromone or other attractant, or a pheromone combined with another substance, or another substance, or a combination of substances, known to attract ovipositing (egg laying) gravid female mosquitoes, from a carrier. The release rate is adjustable and controllable by the optional addition of one or more additives to the carrier(s) and is calculated to last for several weeks or more. The carrier amalgamation is formed into an emulsion, or a thin coating and placed on or within the mosquito control device which may float on the water or sink partially or completely to the bottom. As the substance naturally biodegrades or otherwise dissolves, dissipates or diffuses, the attractants that have been dispersed within are liberated to their surroundings and their scent is picked up by gravid female mosquitoes who follow the scent to its source and deposit (oviposit) their eggs. The amount of attractant is adjustable and variable as to the species being targeted and is calculated to be sufficient to provide attractancy for several weeks or more. A larvicide may be incorporated within this amalgamation or it may be separate from it, but always present at the same site.

The release rate of the attractant from the carrier is controlled by the selection of the carrier(s), by the respective concentrations of the carrier(s), by the type and concentrations of the attractant either singly or combinations thereof, by the physical properties and characteristics of the carrier/attractant combination, by the presence or absence of an additive such as antioxidants and/or volatility suppressants, by the additives type and concentration, by the application conditions, by the weather, and by the season. Volatility suppressants decrease the release rate of the attractant(s). Antioxidants such as vitamin E increase the stability of the attractant(s) and slow its degradation and oxidation. Effervescents such as carbonates can bring entrapped compounds to the surface.

The compound thus derived is versatile in that the employed variables allow preparation of compositions having a slow or fast release of large or small amounts of attractant at a more or less continuous and constant rate during the predetermined time. For instance, if an attractant described herein were to be incorporated into what is commonly referred to as the “mosquito donut” it would be important to design the controlled release substance to perform within a 3-4 week cycle since that is the window within which the larvicide BTI associated with this device remains lethal. Similarly, if included in a “No Maintenance Lethal Mosquito Breeding Trap”, the amalgamation should be designed to perform over a six month period if it is to be used during the mosquito season in North America, or alternately over a longer period if used in countries on or bordering the equator where mosquitoes breed year-round, and it should be designed for the attractant of the mosquito specie being targeted. In no case should the attractant be designed to perform for a longer period of time than the time period within which the properties of the associated larvicide remain lethal as this condition could result in the breeding of mosquitoes.

All the above listed parameters are variable and their variation provides compositions having different release rates of attractants. All variations of these properties are intended to be within the scope of the invention.

### I. Bioactive Agents

a. Primary Bioactive Agents

The primary bioactive agents of this invention are the Secondary Metabolite(s) of the fungus Trichoderma Viride and its underlying molecular structure(s), the pheromone heterocyclic diasteroiomeric lactone mixture, (5R,65)-hexadecanolide, 3 Methyl indole, lactone, epsilon-caprolactone, 6-hexanolactone, p-cresol, the wood inhabiting Fungus Polyporus spp., and its underlying molecular structure(s), and culture filtrates of B. thuringiensis var. israelensis (wild type), B.t.var. Israelensis (mutant) and B.sphaericus, Psychrobacter immobilis, Sphingobacterium multivorum. These chemical cues, when released alone or in combinations and at certain concentrations, are attractive to gravid female mosquitoes, and in particular to subgroups of the Culex, Aedes, and Anopholes species, vectors of malaria, dengue and dengue hemorrhagic fever, lymphatic filariasis, west nile virus and encephalitis, to name a few, and induce these vectors to oviposit at the source. They may be added singly or in two or more combinations in amounts from 0.0001% to 20% by weight.

b. Secondary Bioactive Agents

Secondary bioactive agents are selected from the group of compounds such as lures, juvenile hormones, pesticides, fungicides, herbicides, nutrients and micronutrients, bacteria (such as Bacillus thuringiensis), insecticides and larvicides such as Temephos and Spinosad, insect growth regulators such as Methoprene, effervescents, and insect pathogenic viruses. Secondary bioactive agents are added in amounts from 0.0001% to 20%, preferably between 1%-5% by weight. As with the Primary Bioactive Agents, Secondary Bioactive Agents may be added singly or in combinations of two or more.

### II. Carriers

Examples of commercial attractant dispensers, or carriers, that are made from plastic are microcapsules, trilaminates, capillaries, ropes (hollow tubes), and liquid flowables. These dispensers release the attractant by evaporation from capillaries, by diffusion through a polymeric dispenser, or by diffusion through a microcapsule wall. The preferred embodiment of this application is a biodegradable carrier and that is what will be described in detail. Biodegradable carriers of the invention are gypsum, wax such as beeswax, lanolin, shellac wax, carnauba wax, fruit wax, candelilla wax, other waxes such as microcrystalline, ozocerite, ceresin, montan, polyethylene glycol sometimes called carbowax, charcoal, or, preferably, paraffin compositions able to form solid blocks or granules of an aqueous emulsion in amounts from 0.005%-100% by weight, into which the attractant(s) have been more or less equally dispersed. The attractant(s) are released in a controlled and continuous manner as the carrier degrades by evaporation or dissolution or simply by normal molecular diffusion. These carriers may be used singly or in combinations of two or more.

### III. Additives

A variety of additives may be incorporated into amalgamations of the biodegradable carrier and attractant(s). These additives typically change and/or enhance the physical characteristics of the carrier material and are suitable for designing compositions having specific requirements as to the release rate and the amount of the released attractant(s), protection of the carrier composition against destruction by weather conditions, etc. These additives are, among others, plasticizers, volatility suppressants, antioxidants, lipids, various ultraviolet blockers and absorbers, or antimicrobials, vegetable dye, tiger prawn and carpet shell rinse, added in amounts from 0.001%-20%, preferably between 1%-6% by weight. Emulsifiers such as lecithin and modified lecithins, mono and diglycerides, sorbitan monopalmitate, sorbitan monooleate, sorbitan monolaurate, polyoxyethylene-sorbitan monooleate, fatty acids, lipids, etc. provide or improve emulsification properties of the composition and are added in amounts from 1%-10% by weight.

### IV. Formulation of the Composition

The following is a preferred embodiment for the formulation of one such composition which targets the Culex family of mosquito vectors and more specifically Culex quinquefasciatus. A typical formulation of the invention is made by mixing paraffin in amounts from 10%-100%, preferably about 35%, depending on the type of wax and the desired properties of the coating, with about from 50% to 90% water, preferably about 60%. The oviposition pheromone heterocyclie diasteroisomeric lactone mixture, (5R,6S)-hexadecanolide is added in an amount from 0.001% to about 5%, preferably about 2%. The chemical 3-methylindole, commonly known as Skatole, is added from 2% to 20%, preferably, 10%.

To formulate the composition, the paraffin is first heated under constant stirring, to the melting point temperature, typically from 40 degree C to 80 degree C, preferably 50 degree C depending on the type of paraffin used and water is then added. The attractants are added directly to the molton carrier and the mixture is stirred. The composition is then cooled and stored as an aqueous emulsion, or the mixture is molded into any variety of forms. If used in a No Maintenance Lethal Mosquito Breeding Trap, the composition can be molded in the shape of the familiar “life saver” candy and when floated inside the water container, releases the compound to both the surrounding air and the water.

If added to the “mosquito donut” control device, this same compound with the addition of a UV blocker such as beta-carotene or p-aminobenzoic acid in amounts between 1% and 3%, could be added directly to the gypsum slurry before it is formed into shapes, and if added to the Altosid XR briquet, it could be infused into the briquet under pressure or by means of a vacuum and a carbonate could be added to bring the attractant to the surface.

### Materials and Supplies

As the reader can readily see, the above described Controlled Release Attractant for Gravid Female Mosquitoes is highly technical and should only be attempted by those familiar in the art. The following is a list of manufacturers and suppliers for the exotic ingredients of the compositions described above:

Primary bioactive agents:
Vector Control Research Laboratory, Pondicherry, India—Secondary metabolites of the fungus trichoderma viride and polyporus spp.
ISCA Technologies, Inc. Riverside, Calif.—The oviposition pheromone heterocyclie diasteroisomeric lactone mixture, (5R,6S)-hexadecanolide.
Bede Corporation, New Jersey—3-Methylindole

Some of the listed materials can also be synthesized by those familiar in the art. Other carriers and additives can be found from any well stocked chemical supply distributor, pharmacy and chemical manufacturers, through catalogs, and the internet.

### Conclusion

Accordingly, although the description above contains many specificities, these should not be construed as limiting the scope of the invention but merely providing illustrations of some of the presently preferred embodiments. Thus the scope of the invention should be determined by the appended claims and their legal equivalents, rather than by the examples given.

1. A controlled release composition consisting of a carrier embedded with one or more substances known to attract gravid female mosquitoes and to induce them to deposit their eggs at site. The carrier releases the attracting substance(s) by normal molecular migration, evaporation, degradation, diffusion, or erosion over a period of several weeks or longer. Said carrier and attracting substance(s) to be combined or otherwise deployed in the presence of a larvicide.

2. A controlled release device as described in claim 1 that is biodegradable.

3. A controlled release device as described in claim 1 including the substance 3-methyl indole.

4. A controlled release device as described in claim 1 including the heterocyclic diasteroisomeric lactone mixture, (5R,6S)-acetetoxy-5-hexadecanolide.

5. A controlled release device as described in claim 1 including the combination 3-methyl indole and the heterocyclic diasteroisomeric lactone mixture, (5R,6S)-acetetoxy-5-hexadecanolide.

6. A controlled release device as described in claim 1 including an infusion from the wood inhabiting fungus Polyporus spp.

7. A controlled release device as described in claim 1 including the secondary metabolite(s) of the fungus Trichoderma viride.

8. A controlled release device as described in claim 1, wherein the carrier is selected from the group consisting of paraffin, carnauba wax, beeswax, candelilla wax, fruit wax, carbowax, lanolin, shellac wax, bayberry wax, sugar cane wax, microcrystalline wax, ozocerite, ceresin, montan wax, polyethylene glycol, and combinations thereof.
